(19) United States
(12) Patent Application Publication
(10) Pub. No.: US 2015/0009528 A1
(43) Pub. Date: Jan. 8, 2015

(54) IMAGE FORMING APPARATUS, INFORMATION PROCESSOR, NON-TRANSITORY COMPUTER READABLE MEDIUM, AND IMAGE FORMING METHOD

(71) Applicant: Fuji Xerox Co., Ltd., Tokyo (JP)

(72) Inventor: Yoshihiro SEKINE, Kanagawa (JP)

(73) Assignee: Fuji Xerox Co., Ltd., Tokyo (JP)

(21) Appl. No.: 14/218,437

(22) Filed: Mar. 18, 2014

(30) Foreign Application Priority Data
Jul. 2, 2013 (JP) 2013-138567

(51) Int. Cl. G06F 3/12

(52) U.S. Cl. CPC G06F 3/1279; G06F 3/1272; G06F 3/1292; G06F 3/1205
USPC 358/1.15

(57) ABSTRACT

An image forming apparatus includes a display controller. The display controller displays an operable image if a predetermined first operation is performed on a margin of a screen displayed in a display area displaying a portion of a display target, and if it is determined that the operable image included in the display target that appears or disappears in accordance with a second operation of moving the screen is not displayed on the screen on the basis of a relationship between a distance to a position of the image in the display target including the screen, an operation amount of the second operation, and a size of the display area.

### CROSS-REFERENCE TO RELATED APPLICATIONS

This application is based on and claims priority under 35 USC 119 from Japanese Patent Application No. 2013-138567 filed Jul. 2, 2013.

### BACKGROUND

(i) Technical Field

The present invention relates to an image forming apparatus, an information processor, a non-transitory computer readable medium, and an image forming method.

(ii) Related Art

On a display of a cellular phone or a personal computer (PC), a display target such as a World Wide Web (Web) page may exceed in size a display area (a window, for example). A portion of the display target failing to be displayed in the display area is displayed by a scrolling operation of moving a screen vertically or horizontally, for example.

The display target may include various buttons (command buttons, for example) to be pressed by an operation of a user. These buttons may be arranged in, for example, an upper or lower end portion of the display target. If these buttons are intended to be pressed when a central portion of the display target is displayed in the display area, the scrolling operation is performed to display the buttons in the display area. If the display target is vertically long, a large amount of scrolling operation is required to display the buttons to be pressed.

### SUMMARY

According to an aspect of the invention, there is provided an image forming apparatus including a display controller. The display controller displays an operable image if a predetermined first operation is performed on a margin of a screen displayed in a display area displaying a portion of a display target, and if it is determined that the operable image included in the display target that appears or disappears in accordance with a second operation of moving the screen is not displayed on the screen on the basis of a relationship between a distance to a position of the image in the display target including the screen, an operation amount of the second operation, and a size of the display area.

### BRIEF DESCRIPTION OF THE DRAWINGS

An exemplary embodiment of the present invention will be described in detail based on the following figures, wherein:

FIG. 1 is a diagram illustrating an overview of an image forming system;

FIG. 2A is an example of a block diagram of an image forming apparatus, and FIG. 2B illustrates an example of a positional information table;

FIG. 3 illustrates an example of the hardware configuration of the image forming apparatus;

FIG. 4 is a flowchart illustrating an example of the operation of the image forming apparatus;

FIG. 5 is a diagram for illustrating determination of whether or not command images and so forth are hidden;

FIG. 6A illustrates an example of a screen operation, and FIG. 6B illustrates an example of the command images and so forth displayed on a display;

FIG. 7A illustrates an example of the screen operation, and FIG. 7B illustrates an example of the command images and so forth displayed on the display;

FIG. 8A illustrates an example of the screen operation, and FIG. 8B illustrates an example of the command images displayed on the display;

FIG. 9A illustrates an example of the screen operation, and FIG. 9B illustrates an example of navigation images displayed on the display;

FIG. 10A illustrates an example of the screen operation, and FIG. 10B illustrates an example of the command images and so forth displayed on the display; and

FIG. 11A illustrates an example of the screen operation, and FIG. 11B illustrates an example of the command images and so forth displayed on the display.

### DETAILED DESCRIPTION

An exemplary embodiment for implementing the present invention will be described below with reference to the drawings.

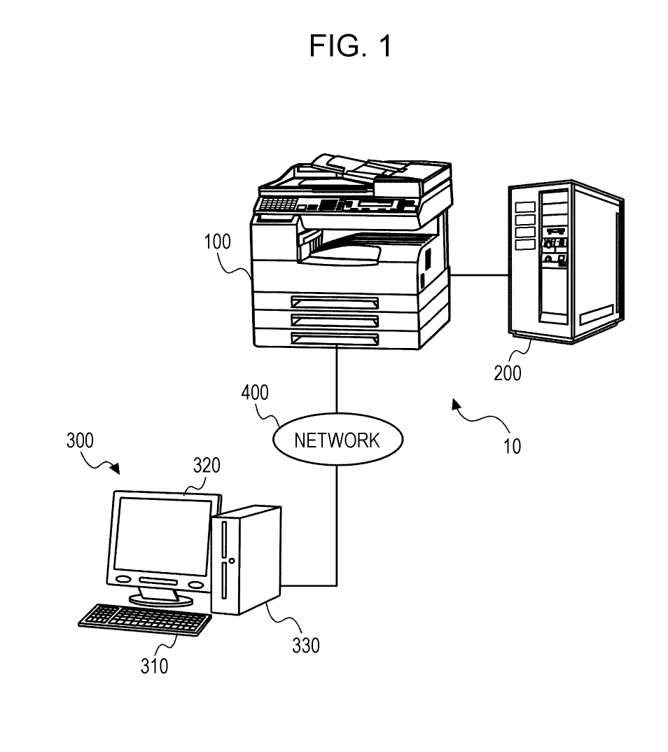

FIG. 1 is a diagram illustrating an overview of an image forming system 10. As illustrated in FIG. 1, the image forming system 10 includes an image forming apparatus 100 and an information processor 200. The image forming apparatus 100 and the information processor 200 are connected by a communication cable including a universal serial bus (USB) cable, for example.

The image forming apparatus 100 is an apparatus having at least one of a scanning function, a copying function, a communication function including facsimile communication, and a printing function. For example, if respective images recorded on two recording sheets are read by the use of the scanning function of the image forming apparatus 100, two pieces of image information are generated.

The information processor 200 is an apparatus that, for example, captures the two pieces of image information generated by the image forming apparatus 100, adds a specific color to the difference between the two pieces of image information, and outputs a resultant image to the image forming apparatus 100. The image forming apparatus 100 prints the image by using the printing function. Thereby, the difference between two images is revealed. The information processor 200 is not limited to the apparatus that exhibits the above-described functions, if the information processor 200 is an apparatus that exhibits functions accompanying various functions of the image forming apparatus 100 (an optional product, for example). Further, the information processor 200 may be an apparatus that provides a service without accompanying various functions of the image forming apparatus 100 (a general-purpose server, for example), such as a server that manages the schedule of a managed person.

The image forming apparatus 100 is connected to a personal computer (PC) 300 via a network 400, such as a local area network (LAN) or the Internet. The PC 300 includes an input device 310, a display 320, and a controller 330. The input device 310 includes, for example, a keyboard and a pointing device (a mouse, for example). The display 320 includes, for example, a liquid crystal display and a touch panel. The touch panel is a display having a function of allowing input of a pointed position. The pointed position is specified by a pointing unit, such as a finger of a user or a pen-type pointing device (a touch pen, for example). The pointed position may be specified by a mouse cursor. The controller 330 controls the operations of the input device 310 and the display 320.

The above-described display 320 displays on a screen thereof a display area (referred to as a window as appropriate). It is possible to move the display position of the display area, and to display plural display areas as superimposed on one another. The display area displays therein, for example, a setting screen that allows settings of the image forming apparatus 100. The user performs various settings on the image forming apparatus 100 by operating the input device 310 or the display 320.

Although the image forming apparatus 100 and the PC 300 are connected via the network 400 in FIG. 1, the information processor 200 and the PC 300 may be connected via the network 400. With this configuration, a setting screen that allows settings of the information processor 200 is displayed on the screen of the display 320, thereby allowing the user to perform various settings on the information processor 200. Further, the setting screen may be displayed on a display panel of the image forming apparatus 100. The PC 300 may be replaced by a mobile information terminal including a cellular phone.

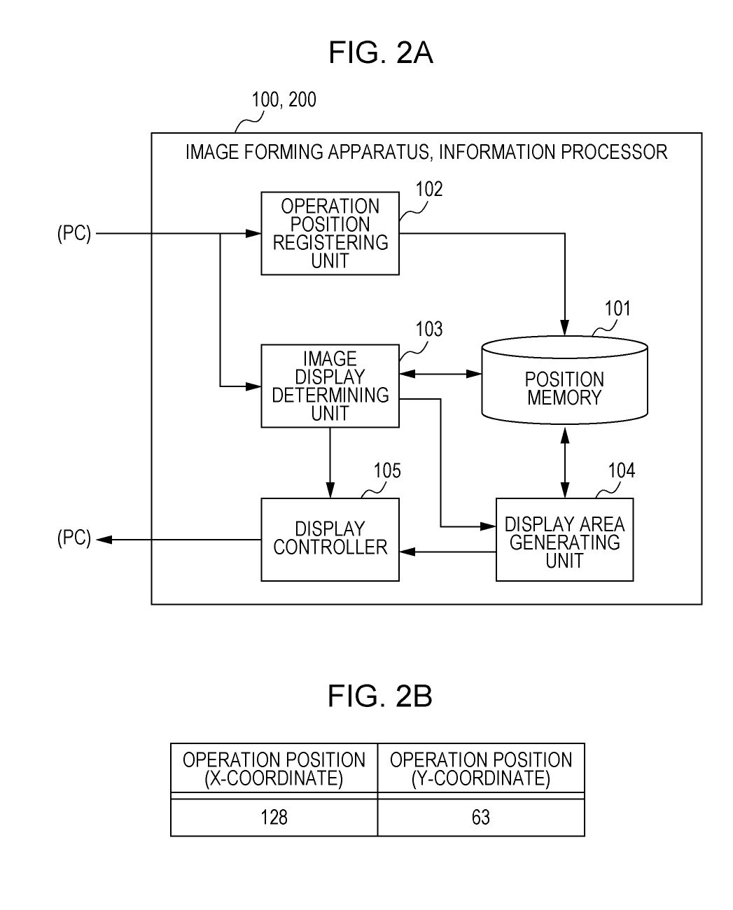

Subsequently, the functions exhibited by the image forming apparatus 100 will be described with reference to FIGS. 2A and 2B.

FIG. 2A is an example of a block diagram of the image forming apparatus 100. FIG. 2B illustrates an example of a positional information table. The various functions exhibited by the image forming apparatus 100 may be provided to the information processor 200 such that the information processor 200 exhibits the various functions.

As illustrated in FIG. 2A, the image forming apparatus 100 includes a position memory 101, an operation position registering unit 102, an image display determining unit 103, a display area generating unit 104, and a display controller 105.

The position memory 101 stores the positional information table. As illustrated in FIG. 2B, the positional information table stores positional information specified by an operation. The operation may be an input operation or a pointing operation, such as double-clicking with a mouse or double-tapping with a finger or a pen, for example. The operation may also be single-clicking or single-tapping.

The operation position registering unit 102 receives the positional information transmitted from the PC 300, and registers the received positional information in the position memory 101. For example, if an operation such as double-tapping is performed on a margin of a screen displayed in a window on the display 320, positional information specified by the operation is transmitted from the PC 300. The operation position registering unit 102 receives and registers the positional information in the position memory 101. Thereby, the operated position is held. The positional information may be an absolute position relative to the origin set to one of four corners of the display 320 or a relative position relative to the origin set to one of four corners of the window.

The image display determining unit 103 determines whether or not the screen currently displays thereon an operable image included in a display target that appears or disappears in accordance with a scrolling operation of moving the screen, on the basis of the relationship between the distance to the position of the image in the display target including the screen, the operation amount of the scrolling operation, and the size of the window. The operable image may be, for example, a command image representing a command button such as a save button or a start button or a navigation image representing a later-described navigation item. The navigation image is an image that causes a change or transition of the setting screen. For example, if the distance to the position of the command image is greater than the sum of the operation amount of the scrolling operation and the size of the window, the image display determining unit 103 determines that the command image is not displayed.

If the image display determining unit 103 determines that the image is not displayed, the display area generating unit 104 generates another window different from the above-described window. Another window may be a pop-up window, for example.

If the image display determining unit 103 determines that the image is not displayed, the display controller 105 displays the command image or the navigation image. For example, the display controller 105 displays the command image or the like in the another window generated by the display area generating unit 104. The display controller 105 also executes various other display operations.

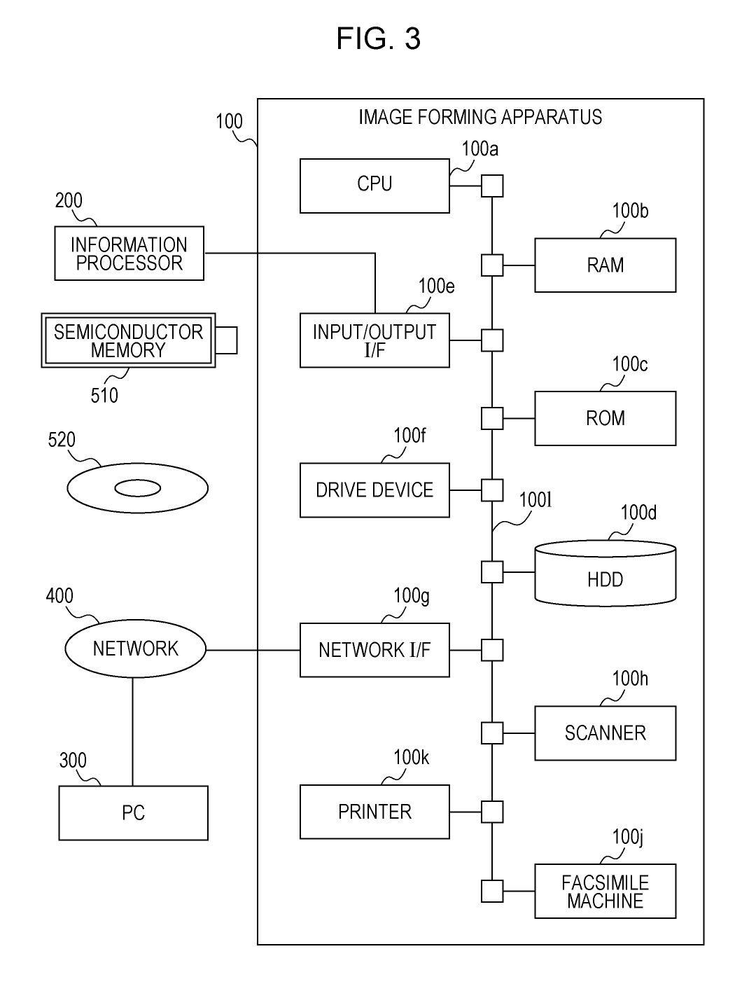

Subsequently, a hardware configuration of the image forming apparatus 100 will be described with reference to FIG. 3.

FIG. 3 illustrates an example of the hardware configuration of the image forming apparatus 100. As illustrated in FIG. 3, the image forming apparatus 100 includes a central processing unit (CPU) 100a, a random access memory (RAM) 100b, a read only memory (ROM) 100c, and a hard disc drive (HDD) 100d. The image forming apparatus 100 also includes an input/output interface (I/F) 100e, a drive device 100f, and a network I/F 100g. The image forming apparatus 100 further includes a scanner 100h, a facsimile machine 100j, and a printer 100k. These devices and apparatuses 100a to 100k are connected to one another by a bus 1001, for example. At least the CPU 100a and the RAM 100b cooperate to realize a computer. The scanner 100h and the printer 100k cooperate to realize a copier.

The input/output I/F 100e includes a USB port, for example. The input/output I/F 100e is connected to the information processor 200 or a semiconductor memory 510. The semiconductor memory 510 may be a USB memory or a flash memory, for example. The input/output I/F 100e reads a program or data stored in the semiconductor memory 510.

A portable recording medium 520 is inserted in the drive device 100f. The portable recording medium 520 may be a removable disc, such as a compact disc (CD)-ROM or a digital versatile disc (DVD), for example. The drive device 100f reads a program or data recorded on the portable recording medium 520.

The network I/F 100g includes a local area network (LAN) interface (a LAN card or a network adapter, for example). The PC 300 is connected to the network I/F 100g via the network 400 including a router and a switch.

The above-described RAM 100b reads a program stored in one of the ROM 100c, the HDD 100d, and the semiconductor memory 510. The RAM 100b also reads a program recorded on the portable recording medium 520. The CPU 100a executes the read program to thereby realize the functions of the respective units 102 to 105 included in the image forming apparatus 100.

The above-described program may follow a later-described flowchart. Further, the hardware configuration of the information processor 200 is basically similar to the hardware configuration of the image forming apparatus 100 except for the scanner 100h, the copier, the facsimile machine 100j, and the printer 100k described above.

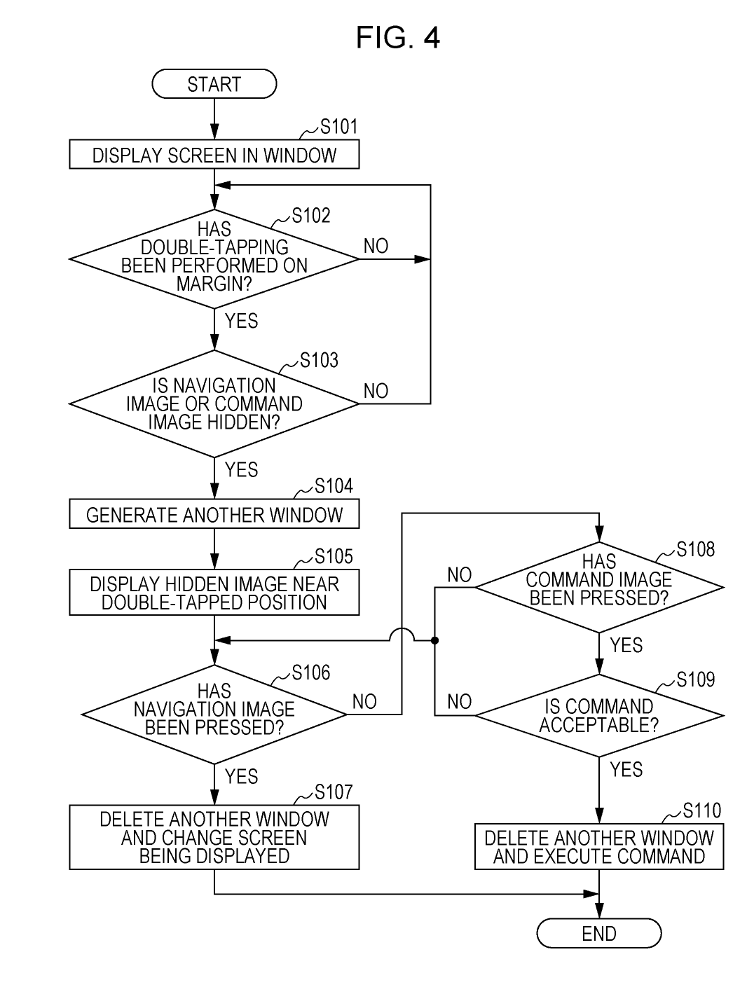

Subsequently, the operation of the image forming apparatus 100 will be described with reference to FIGS. 4 to 6B. The operation of the information processor 200 is basically similar to the operation of the image forming apparatus 100.

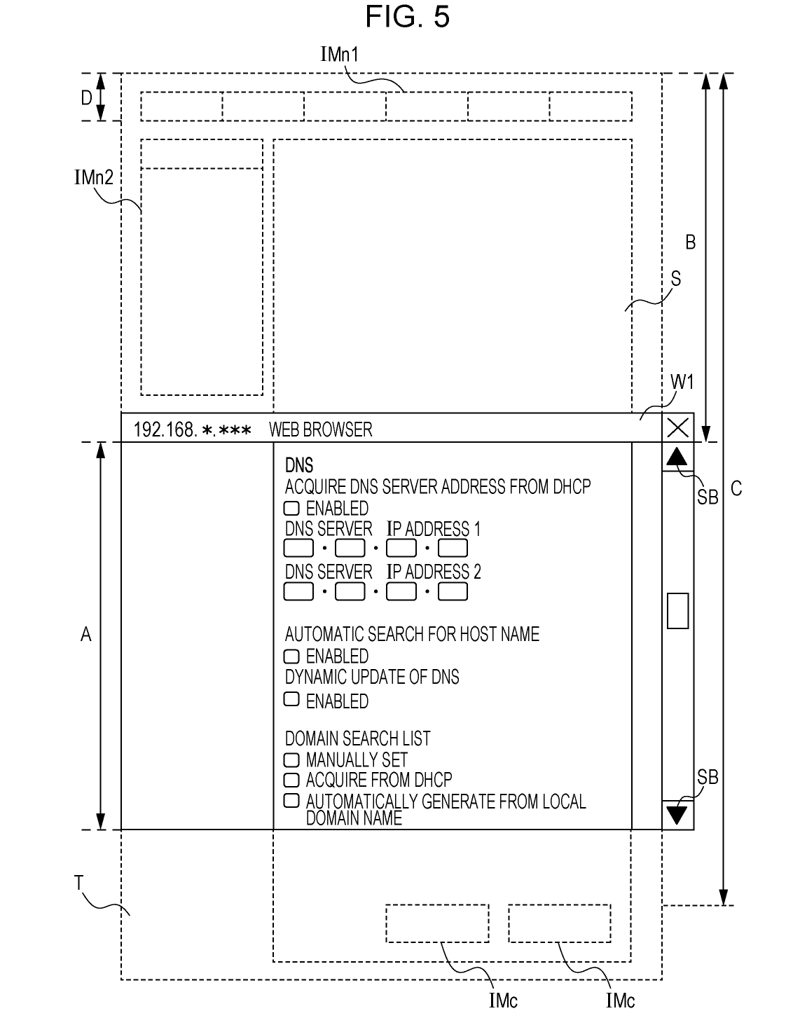

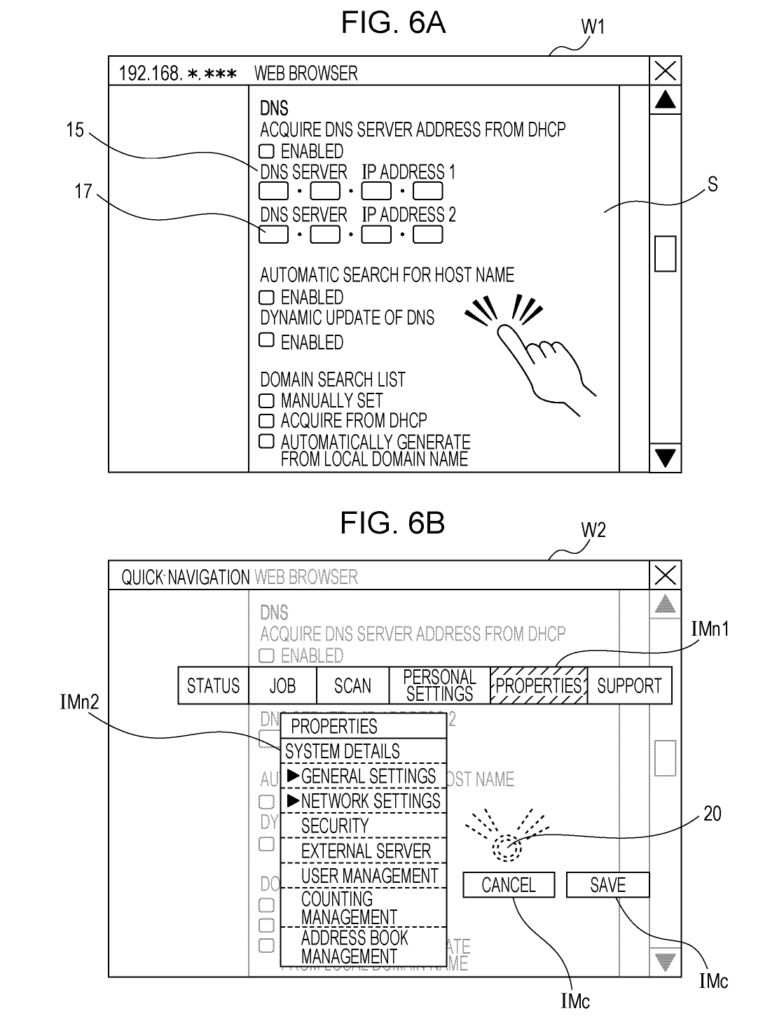

FIG. 4 is a flowchart illustrating an example of the operation of the image forming apparatus 100. FIG. 5 is a diagram for illustrating determination of whether or not command images and so forth are hidden. FIG. 6A illustrates an example of a screen operation. FIG. 6B illustrates an example of the command images and so forth displayed on the display 320.

As illustrated in FIG. 4, the display controller 105 first displays a screen in a window on the display 320 (step S101). More specifically, if an input for causing the display 320 to display the setting screen for the image forming apparatus 100 is received through the input device 310 or the display 320, the display controller 105 displays a display target T in a window W1, as illustrated in FIG. 5.

Since the display target T is too large to fit in the window W1, the window W1 displays therein a portion of the display target T. Therefore, the remaining portion of the display target T is hidden outside the window W1. The remaining portion of the display target T includes command images IMc and navigation images IMn1 and IMn2 arranged in a hidden state. If one of scroll buttons SB is operated (pressed), the display target T moves relatively upward or downward, thereby displaying the remaining portion of the display target T in the window W1. As a result, the command images IMc or the navigation images IMn1 and IMn2 appear in the window W1.

Then, as illustrated in FIG. 4, the image display determining unit 103 determines whether or not double-tapping has been performed on a margin (step S102). More specifically, the image display determining unit 103 determines whether or not double-tapping has been performed on a margin of a setting screen S, as illustrated in FIG. 6A. The margin of the screen S basically refers to a portion of the setting screen S excluding setting item descriptions 15 and setting fields 17. For example, if double-tapping is performed on the display 320, positional information representing the double-tapped position is transmitted to the operation position registering unit 102, and operation information indicating that double-tapping has been performed is transmitted to the image display determining unit 103. The operation position registering unit 102 registers the received positional information in the position memory 101. Upon receipt of the operation information, the image display determining unit 103 acquires the positional information from the position memory 101, and determines whether or not the portion of the setting screen S excluding the setting item descriptions 15 and the setting fields 17 has been operated by comparing the acquired positional information with a Web page that defines the layout of the setting item descriptions 15 and the setting fields 17. If the portion of the setting screen S excluding the setting item descriptions 15 and the setting fields 17 has been operated, it is determined that double-tapping has been performed on the margin.

Herein, if double-tapping has been performed on a portion other than the margin, or if single-tapping has been performed on the margin (NO at step S102), the image forming apparatus 100 returns to step S102 without executing the subsequent processes. Meanwhile, if it is determined that double-tapping has been performed on the margin (YES at step S102), the image display determining unit 103 determines whether or not at least one of the navigation images IMn1 and IMn2 and the command images IMc is hidden (step S103). For example, the image display determining unit 103 makes the determination on the basis of the relationship between the distance to the absolute position of the command image IMc in the display target T including the setting screen S, the operation amount of the scrolling operation, and the size of the window W1. Herein, as illustrated in FIG. 5, the size of the above-described window W1 is specified by a size A from the upper end to the lower end of the window W1. The operation amount of the scrolling operation is specified by a size B from the upper end of the display target T to the upper end of the window W1. The distance to the absolute position of the command image IMc is specified by a size C from the upper end of the display target T to the upper end of the command image IMc.

The image display determining unit 103 acquires the specified sizes A to C, and determines whether or not the command image IMc is hidden on the basis of the following determination expression (1).

size A+size B<size C Determination Expression (1)

If the above determination expression (1) is satisfied, it is determined that the command image IMc is hidden.

The image display determining unit 103 makes the determination also on the basis of the relationship between the distance to the absolute position of the navigation image IMn1 in the display target T, the operation amount of the scrolling operation, and the size of the window W1. Herein, as illustrated in FIG. 5, the distance to the absolute position of the navigation image IMn1 is specified by a size D from the upper end of the display target T to the lower end of the navigation image IMn1.

The image display determining unit 103 acquires the specified sizes B and D, and determines whether or not the navigation image IMn1 is hidden on the basis of the following determination expression (2).

size D<size B Determination Expression (2)

If the above determination expression (2) is satisfied, it is determined that the navigation image IMn1 is hidden.

If the size from the upper end of the display target T to the lower end of the navigation image IMn2 is specified, whether or not the navigation image IMn2 is hidden is determined in a similar manner. The determination of whether or not an image is hidden is not limited to the above-described example, and various methods are employable within the above-described scope.

The image display determining unit 103 also determines whether the hidden image is the command image IMc, the navigation image IMn1, or the navigation image IMn2. In the case of the command image IMc, the determination is made on the basis of whether or not the hidden image is a submit button, which is determined on the basis of the presence or absence of a callback. If the hidden image is determined to be a submit button on the basis of the presence of a callback, the hidden image is determined to be the command image IMc. In the case of the navigation image IMn1 or IMn2, the determination is made with the use of the definition of style sheets, such as cascading style sheets (CSS). If the style sheets include information defining a navigation image, the hidden image is determined to be the navigation image IMn1 or IMn2. Accordingly, even if the command image IMc is located on the upper end of the display target T, or if the navigation image IMn1 or IMn2 is located on the lower end of the display target T, not only whether or not an image is hidden but also whether or not the hidden image is the command image IMc, the navigation image IMn1, or the navigation image IMn2 is determined.

Herein, if it is determined that none of the navigation images IMn1 and IMn2 and the command images IMc is hidden (NO at step S103), the image forming apparatus 100 returns to step S102 without executing the subsequent processes. Meanwhile, if it is determined that at least one of the navigation images IMn1 and IMn2 and the command images IMc is hidden (YES at step S103), the display area generating unit 104 generates another window (step S104).

Specifically, if the operable image (the navigation image IMn1 or IMn2 or the command image IMc) is hidden, a hypertext markup language (HTML) file for generating a pop-up window is first generated. Then, if the navigation image IMn1 or IMn2 is hidden, the information defining the navigation image IMn1 or IMn2 is extracted from the style sheets, and the extracted information is incorporated into the generated HTML file. Also in the case of the command image IMc, the extracted information is incorporated into the generated HTML file in a similar manner.

Then, as illustrated in FIG. 4, the display controller 105 displays the hidden image near the double-tapped position (step S105). More specifically, as illustrated in FIG. 6B, a transparent pop-up window W2 having the navigation images IMn1 and IMn2 and the command images IMc arranged therein is displayed on the display 320 near a double-tapped position 20. The double-tapped position 20 is extracted from the position memory 101. With the navigation images IMn1 and IMn2 and the command images IMc arranged near the position 20, the moving distance of a finger to each of the operable navigation images IMn1 and IMn2 and the operable command images IMc is reduced as compared with a case in which these images are not arranged near the position 20.

The navigation images IMn1 and IMn2 and the command images IMc are arranged near the position 20 not to overlap one another. Further, the window W1 and the pop-up window W2, which match in size in FIG. 6B, may be different from each other in size.

Then, the display controller 105 determines whether or not the navigation image IMn1 has been pressed (step S106). If it is determined that the navigation image IMn1 has been pressed (YES at step S106), the display controller 105 deletes the another window and changes the screen being displayed (step S107). For example, if a navigation item “PERSONAL SETTINGS” is pressed in FIG. 6B when a navigation item “PROPERTIES” of the navigation image IMn1 is selected, the pop-up window W2 is deleted. Thereafter, the navigation image IMn2 is changed to items related to the navigation item “PERSONAL SETTINGS,” and the setting screen S is changed to the setting screen S related to the navigation item “PERSONAL SETTINGS.” If one of the items of the navigation image IMn2 is pressed, the setting screen S not displaying corresponding items transits to the setting screen S displaying the corresponding items.

Meanwhile, if it is not determined that the navigation image IMn1 has been pressed (NO at step S106), the display controller 105 determines whether or not the command image IMc has been pressed (step S108). If it is determined that the command image IMc has been pressed (YES at step S108), the display controller 105 further determines whether or not a corresponding command is acceptable (step S109). If it is determined that the command is acceptable, the display controller 105 deletes the another window and executes the command (step S110).

For example, if the command image IMc “SAVE” is pressed in FIG. 6B, a determination is made on whether the contents input to the setting fields 17 are valid or invalid and whether or not there is a setting omission. Then, if it is determined that the command is acceptable on the basis of the validity of the contents input to the setting fields 17 and no setting omission, the pop-up window W2 is deleted. Thereafter, a save command is executed, and the settings are stored in the image forming apparatus 100.

As described above, the user is not required to perform the scrolling operation even if the display target T exceeds the window W1 in size and thus the operable image, such as the navigation image IMn1 or IMn2 or the command image IMc, is hidden. Further, the operable image is not exempted from the scrolling operation in the window W1, thereby allowing extensive use of the area of the window W1. That is, the range of utilization of the display area is expanded.

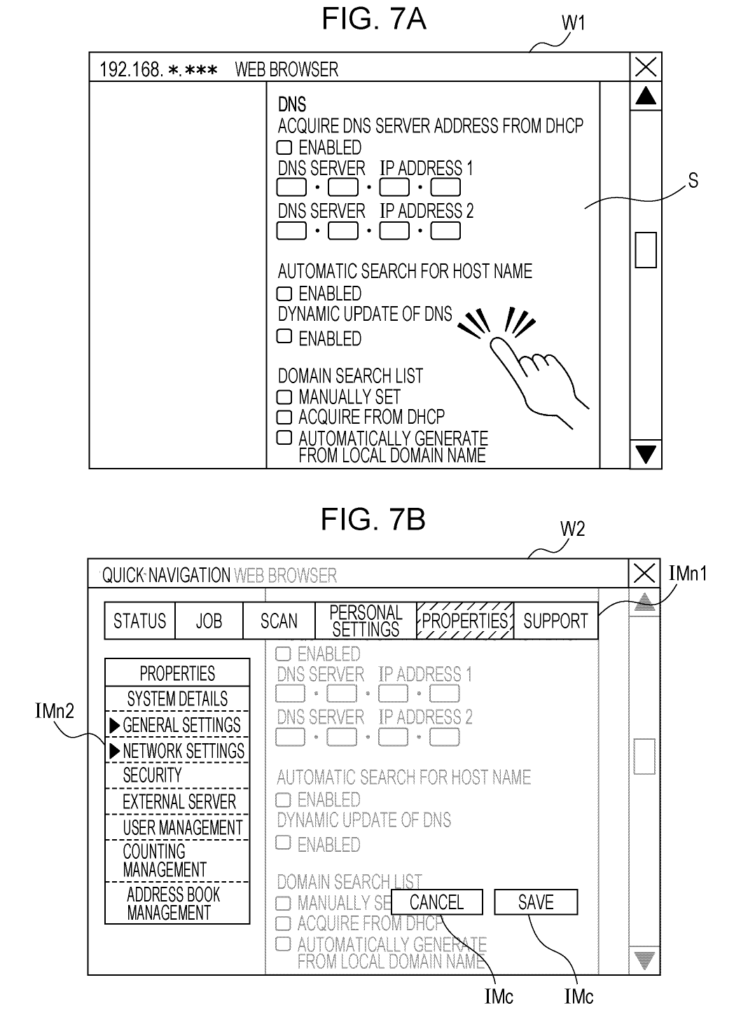

Subsequently, modified examples of the above-described exemplary embodiment will be sequentially described with reference to FIGS. 7A to 11B.

FIG. 7A illustrates an example of the screen operation. FIG. 7B illustrates an example of the command images IMc and so forth displayed on the display 320.

If double-tapping is performed on the margin of the setting screen S when the navigation images IMn1 and IMn2 and the command images IMc are both hidden, as illustrated in FIG. 7A, the display controller 105 may display the navigation images IMn1 and IMn2 and the command images IMc in a layout close to the layout thereof in the display target T, as illustrated in FIG. 7B. The navigation images IMn1 and IMn2 and the command images IMc are displayed not near the double-tapped position but in a layout close to the layout thereof in the display target T. Therefore, the user is allowed to perform an operation in a relatively familiar image layout.

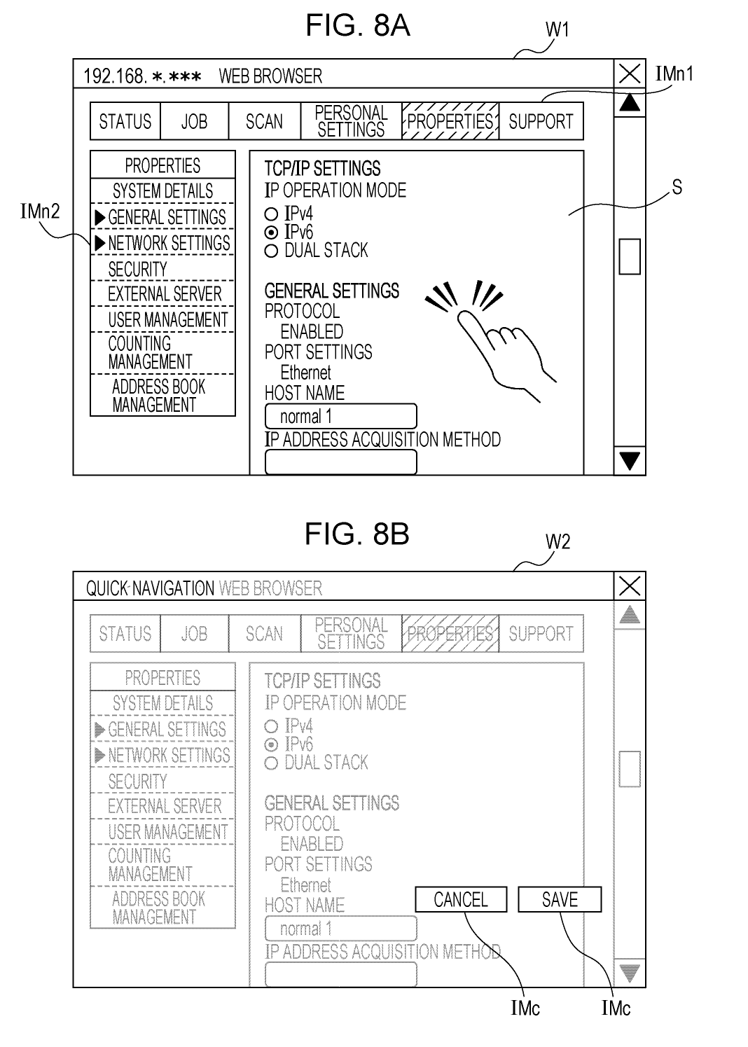

FIG. 8A illustrates an example of the screen operation. FIG. 8B illustrates an example of the command images IMc displayed on the display 320.

If double-tapping is performed on the margin of the setting screen S when the navigation images IMn1 and IMn2 are displayed and the command images IMc are hidden, as illustrated in FIG. 8A, the display controller 105 may display the command images IMc in a layout close to the layout thereof in the display target T, as illustrated in FIG. 8B. When the user wants to save the settings by changing setting items displayed in an upper portion of the setting screen S and not changing setting items hidden in a lower portion of the setting screen S, the user is allowed to perform an operation of pressing the command button “SAVE” without performing the scrolling operation.

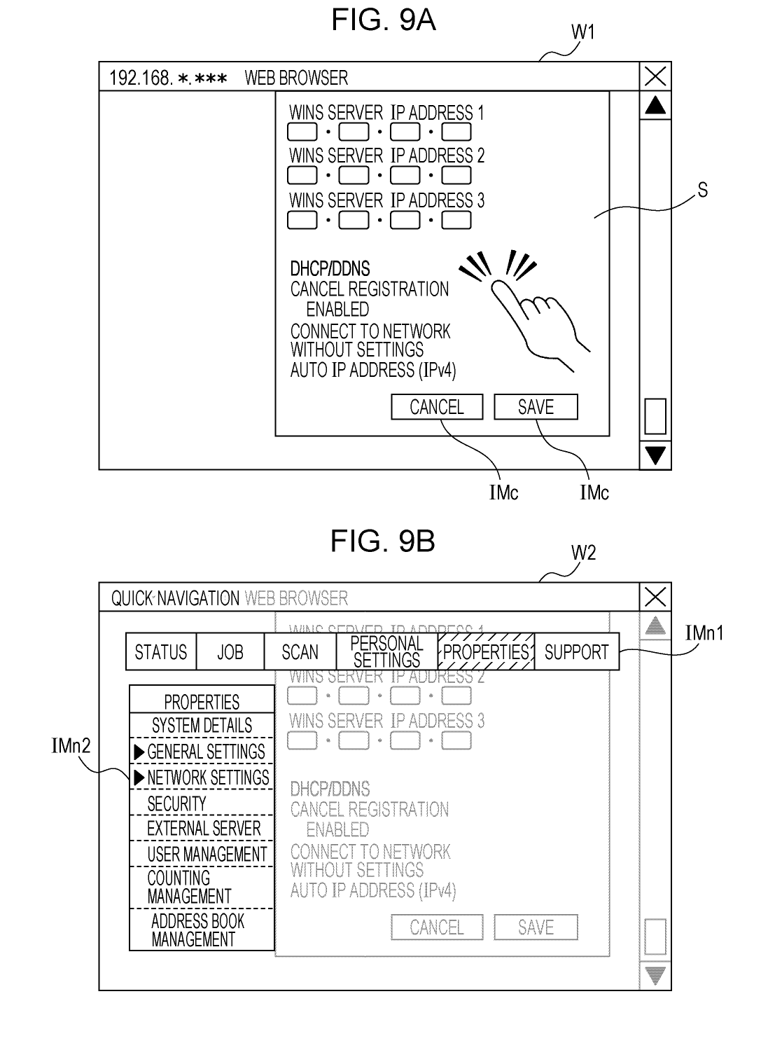

FIG. 9A illustrates an example of the screen operation. FIG. 9B illustrates an example of the navigation images IMn1 and IMn2 displayed on the display 320.

If double-tapping is performed on the margin of the setting screen S when the navigation images IMn1 and IMn2 are hidden and the command images IMc are displayed, as illustrated in FIG. 9A, the display controller 105 may display the navigation images IMn1 and IMn2 in a layout close to the layout thereof in the display target T, as illustrated in FIG. 9B. When the user wants to change the setting screen S after checking setting items displayed in a lower portion of the setting screen S, the user is allowed to perform an operation of pressing a navigation item of the navigation image IMn1 without performing the scrolling operation.

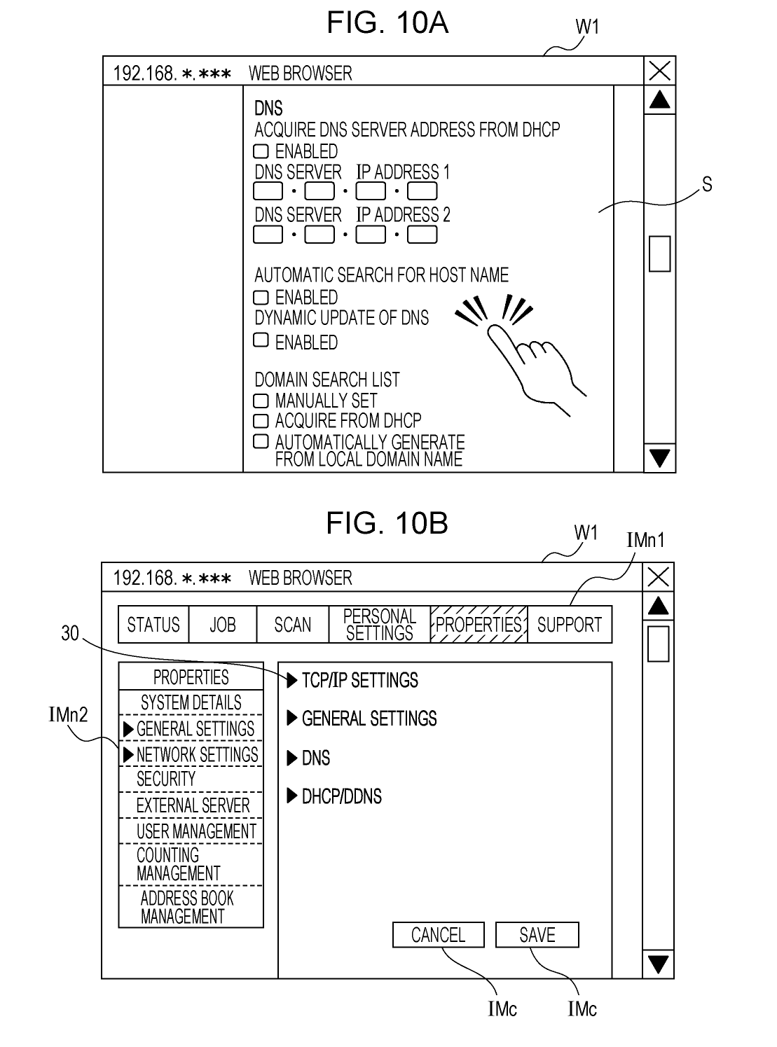

FIG. 10A illustrates an example of the screen operation. FIG. 10B illustrates an example of the command images IMc and so forth displayed on the display 320.

If double-tapping is performed on the margin of the setting screen S when the navigation images IMn1 and IMn2 and the command images IMc are both hidden, as illustrated in FIG. 10A, the display controller 105 may display both the navigation images IMn1 and IMn2 and the command images IMc by folding or shrinking the display target T to fit in the window W1, as illustrated in FIG. 10B. The folding is performed at, for example, major headings of the setting items. If a button 30 provided to the head of a major heading is pressed, setting items related to the major heading are expanded. It is therefore possible to allow the user to operate one of the navigation images IMn1 and IMn2 and the command images IMc without performing the scrolling operation, while ensuring the visibility of the headings.

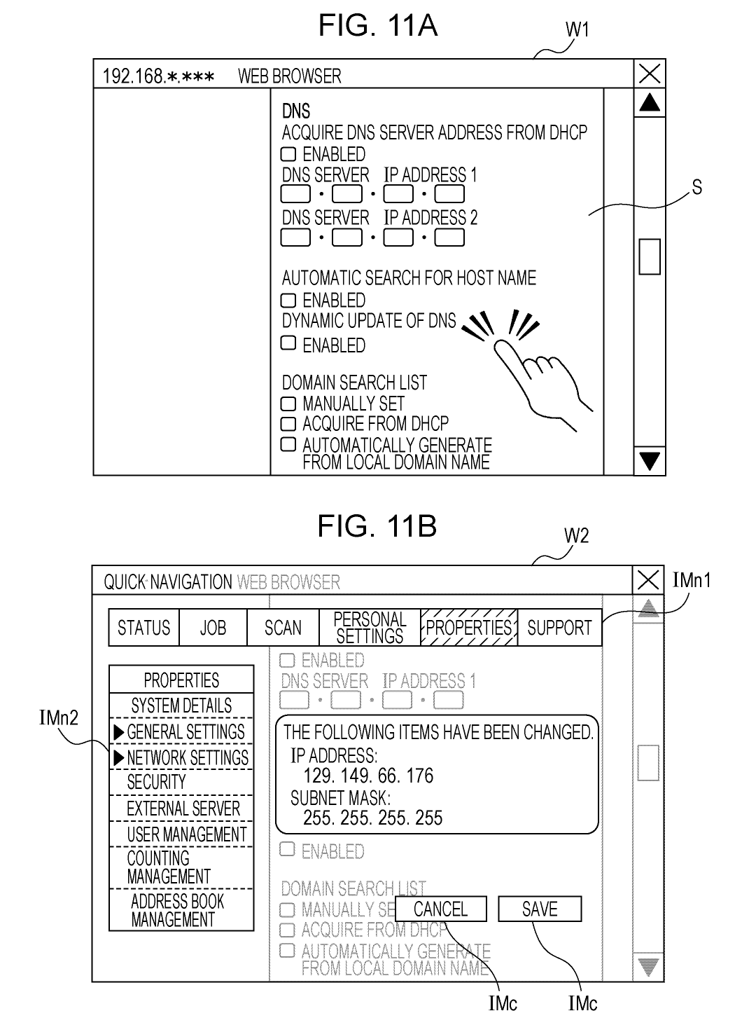

FIG. 11A illustrates an example of the screen operation. FIG. 11B illustrates an example of the command images IMc and so forth displayed on the display 320.

If double-tapping is performed on the margin of the setting screen S after any of the items displayed in the setting screen S is changed when the navigation images IMn1 and IMn2 and the command images IMc are both hidden, as illustrated in FIG. 11A, the display controller 105 may display the changed setting item together with the navigation images IMn1 and IMn2 and the command images IMc, as illustrated in FIG. 11B. Thereby, the user is allowed to perform an operation of pressing the command button “SAVE” after checking the changed item. As described above, if any of the setting items is changed when the present setting items are displayed in the setting fields 17, and if double-tapping is performed in the margin in this state, the changed setting item is displayed on the pop-up window W2. In this process, the changed setting item is displayed not to overlap the navigation images IMn1 and IMn2 and the command images IMc, as illustrated in FIG. 11B.

In the above-described exemplary embodiment and the modified examples thereof, the setting screen has been described as an example. However, the screen is not limited to the setting screen, and may be a screen for performing various inputs, selections, and registrations, for example. In this case, the above-described margin refers to a portion of the screen excluding descriptions of input items, selection items, and registration items, input fields, selection fields, and registration fields. Further, in the above-described exemplary embodiment and the modified examples, the description has been given of the vertical direction as an example. However, the description also applies to the horizontal direction. Further, the images may be displayed in accordance with the combination of the exemplary embodiment and the modified examples thereof, for example. Further, the margin is limited to the margin of the setting screen S, and may include a margin of the display target T, for example.

Further, although the description has been given of an exemplary embodiment of the invention, the invention is not limited to a specific exemplary embodiment of the invention, and may be altered or modified in various ways within the scope of the gist of the invention described in the claims. For example, a program according to an exemplary embodiment of the invention may be provided by a recording medium, such as a CD-ROM, storing the program, let alone by a communication unit. Further, at least one of the units in the above-described block diagram may be realized by hardware, such as a logic circuit. Further, two of the above-described functions may be realized by a single device, and one of the functions may be distributed to two or more devices.

What is claimed is:

1. An image forming apparatus comprising:
a display controller that displays an operable image if a predetermined first operation is performed on a margin of a screen displayed in a display area displaying a portion of a display target, and if it is determined that the operable image included in the display target that appears or disappears in accordance with a second operation of moving the screen is not displayed on the screen on the basis of a relationship between a distance to a position of the image in the display target including the screen, an operation amount of the second operation, and a size of the display area.

2. The image forming apparatus according to claim 1, further comprising:
a determining unit that determines whether or not the operable image is displayed on the screen on the basis of the relationship between the distance to the position of the operable image, the operation amount of the second operation, and the size of the display area,
wherein if the distance to the position is greater than the sum of the operation amount and the size, the determining unit determines that the image is not displayed.

3. The image forming apparatus according to claim 1, wherein the operable image is located in an end portion of the display target.

4. The image forming apparatus according to claim 1, further comprising:
a generating unit that generates another display area different from the display area if it is determined that the operable image is not displayed,
wherein the display controller displays the operable image in the another display area generated by the generating unit.

5. The image forming apparatus according to claim 1, wherein the display controller displays the operable image near a location in which the first operation has been performed.

6. The image forming apparatus according to claim 1, wherein the display controller folds the display target to fit in the display area.

7. The image forming apparatus according to claim 1, wherein if the first operation is performed when the operable image located in one end portion of the display target is displayed in the screen, the display controller displays a screen of an other end portion of the display target in the display area.

8. The image forming apparatus according to claim 1, wherein if the first operation is performed after an item displayed in the screen is changed, the display controller displays the changed item together with the operable image.

9. An information processor comprising:
a display controller that displays an operable image if a predetermined first operation is performed on a margin of a screen displayed in a display area displaying a portion of a display target, and if it is determined that the operable image included in the display target that appears or disappears in accordance with a second operation of moving the screen is not displayed on the screen on the basis of a relationship between a distance to a position of the image in the display target including the screen, an operation amount of the second operation, and a size of the display area.

10. A non-transitory computer readable medium storing a program causing a computer to execute a process for image formation, the process comprising:
displaying an operable image if a predetermined first operation is performed on a margin of a screen displayed in a display area displaying a portion of a display target, and if it is determined that the operable image included in the display target that appears or disappears in accordance with a second operation of moving the screen is not displayed on the screen on the basis of a relationship between a distance to a position of the image in the display target including the screen, an operation amount of the second operation, and a size of the display area.

11. An image forming method comprising:
displaying an operable image if a predetermined first operation is performed on a margin of a screen displayed in a display area displaying a portion of a display target, and if it is determined that the operable image included in the display target that appears or disappears in accordance with a second operation of moving the screen is not displayed on the screen on the basis of a relationship between a distance to a position of the image in the display target including the screen, an operation amount of the second operation, and a size of the display area.
